(19) United States
(12) Patent Application Publication
(10) Pub. No.: US 2025/0180404 A1
(43) Pub. Date: Jun. 5, 2025

(54) Spectrometer With Meniscus Lens Having Integrated Diffraction Grating and Reflector

(71) Applicant: Headwall Photonics Inc., Bolton, MA (US)

(72) Inventors: Daniel Rundlett, Waltham, MA (US); Andromeda Huffman, Waltham, MA (US)

(21) Appl. No.: 18/963,892

(22) Filed: Nov. 29, 2024

Related U.S. Application Data
(60) Provisional application No. 63/604,995, filed on Dec. 1, 2023.

(51) Int. Cl. G01J 3/02; G01J 3/04; G01J 3/18

(52) U.S. Cl. CPC G01J 3/0208; G01J 3/021; G01J 3/04; G01J 3/18

(57) ABSTRACT

An optical spectrometer includes a housing having a light-entrance slit defined therein; a meniscus lens having first and second transmissive regions and a reflective region, the reflective region including a reflector and a diffraction grating; a curved mirror, and a light detector. The meniscus lens is between the light-entrance slit and the curved mirror.

### CROSS-REFERENCE TO RELATED APPLICATIONS

This application claims priority to U.S. Provisional Application No. 63/604,995, titled “Spectrometer With Meniscus Lens Having Integrated Diffraction Grating And Reflector,” filed on Dec. 1, 2023, which is hereby incorporated by reference.

### TECHNICAL FIELD

This application relates generally to optical spectrometers.

### BACKGROUND

Spectrometers are used to measure the wavelengths and relative intensities of light. The spectrum of light produced by an object can be used to determine its physical and/or chemical characteristics.

### SUMMARY

Example embodiments described herein have innovative features, no single one of which is indispensable or solely responsible for their desirable attributes. The following description and drawings set forth certain illustrative implementations of the disclosure in detail, which are indicative of several exemplary ways in which the various principles of the disclosure may be carried out. The illustrative examples, however, are not exhaustive of the many possible embodiments of the disclosure. Without limiting the scope of the claims, some of the advantageous features will now be summarized. Other objects, advantages, and novel features of the disclosure will be set forth in the following detailed description of the disclosure when considered in conjunction with the drawings, which are intended to illustrate, not limit, the invention.

An aspect of the invention is directed to an optical spectrometer comprising a housing having a light-entrance slit defined therein; a meniscus lens having first and second transmissive regions and a reflective region, the reflective region including: a reflector, and a diffraction grating. The optical spectrometer further comprises a curved mirror; and a light detector. The meniscus lens is between the light-entrance slit and the curved mirror, and the optical spectrometer is configured such that: a light enters the optical spectrometer through the light-entrance slit, after entering through the light-entrance slit, the light passes through the first transmissive region of the meniscus lens, after passing through the first transmissive region of the meniscus lens, the light is reflected by a first portion of the curved mirror towards the reflective region of the meniscus lens, after being reflected by the first portion of the curved mirror, the light is diffracted and reflected by the reflective region of the meniscus lens towards a second portion of the curved mirror, after being diffracted and reflected by the reflective region of the meniscus lens, the light is reflected by a second portion of the curved mirror towards the second transmissive region of the meniscus lens, and after being reflected by the second portion of the curved mirror, the light passes through the second transmissive region of the meniscus lens and enters the light detector.

In one or more embodiments, the reflective region is between the first and second transmissive regions. In one or more embodiments, the meniscus lens has first and second sides, the first side is closer to the light-entrance slit and the light detector than the second side, the second side is closer to the curved mirror than the first side, and the second side is defined, in part, by the reflective region.

In one or more embodiments, the meniscus lens has first and second sides, the first side is closer to the light-entrance slit and the light detector than the second side, the second side is closer to the curved mirror than the first side, and the diffraction grating is closer to the first side compared to the reflector. In one or more embodiments, the reflector comprises a coating of gold, aluminum, and/or silver, and the diffraction grating comprises a plurality of grooves. In one or more embodiments, the grooves include triangular, sinusoidal, rectangular, and/or square shapes.

In one or more embodiments, the first side of the meniscus lens is concave, and the second side of the meniscus lens is convex. In one or more embodiments, the meniscus lens comprises a section of a spherical dome. In one or more embodiments, the curved mirror comprises a section of a spherical dome. In one or more embodiments, the curved mirror is formed on a mirror substrate, the mirror substrate having a variable thickness. In one or more embodiments, the first and second transmissive regions are optically transmissive to one or more wavelengths within a wavelength range of 250 nm to 2500 nm.

Another aspect of the invention is directed to an optical spectrometer comprising a housing having a light-entrance slit defined therein; a meniscus lens having first and second transmissive regions and a reflective region, the reflective region including: a reflector, and a diffraction grating. The optical spectrometer further comprises a curved mirror; a light detector; and a spacer disposed on the curved mirror and mechanically supporting the meniscus lens, the spacer defining a cavity, wherein: the meniscus lens is between the light-entrance slit and the curved mirror, and the optical spectrometer is configured such that: a light enters the optical spectrometer through the light-entrance slit, after entering through the light-entrance slit, the light passes through the first transmissive region of the meniscus lens, after passing through the first transmissive region of the meniscus lens, the light passes through the cavity and is reflected by a first portion of the curved mirror towards the reflective region of the meniscus lens, after being reflected by the first portion of the curved mirror, the light passes through the cavity and is diffracted and reflected by the reflective region of the meniscus lens towards a second portion of the curved mirror, after being diffracted and reflected by the reflective region of the meniscus lens, the light passes through the cavity and is reflected by a second portion of the curved mirror towards the second transmissive region of the meniscus lens, and after being reflected by the second portion of the curved mirror, the light passes through the second transmissive region of the meniscus lens and enters the light detector.

In one or more embodiments, the spacer includes: a first wall that mechanically engages a first side of the meniscus lens, and a second wall that mechanically engages a second side of the meniscus lens, the first and second sides on opposing sides of the meniscus lens. In one or more embodiments, the reflective region of the meniscus lens is between the first and second sides.

In one or more embodiments, each of the first and second walls has a respective height, a respective width, and a respective length that are measured with respect to first, second, and third axes, respectively, that are mutually orthogonal, a distance between the meniscus lens and the curved mirror is measured with respect to the first axis, a distance between the first and second walls is measured with respect to the second axis, and the respective width of the first and second walls is variable. In one or more embodiments, each of the first and second walls has a respective first end and a respective second end, the respective first end is closer to the meniscus lens than the respective second end, and the respective width is greater at the respective first end than at the respective second end.

In one or more embodiments, a third wall that mechanically engages a third side of the meniscus lens, and a fourth wall that mechanically engages a fourth side of the meniscus lens. In one or more embodiments, the third wall includes a first fin that mechanically engages the third side of the meniscus lens, and the fourth wall includes a second fin that mechanically engages the third side of the meniscus lens.

Another aspect of the invention is directed an optical spectrometer as described herein; and a computer having an input coupled to an output of the light detector.

Another aspect of the invention is directed an optical spectrometer comprising a housing having a light-entrance slit defined therein; a curved mirror; a meniscus lens having first, second, and third transmissive regions and a reflective region, the reflective region including a reflector and a diffraction grating, wherein: the second transmissive region is between the first and third transmissive regions, and the second transmissive region is between the reflective region and the curved mirror. The optical spectrometer further comprises a light detector. The meniscus lens is between the light-entrance slit and the curved mirror, and the optical spectrometer is configured such that: a light enters the optical spectrometer through the light-entrance slit, after entering through the light-entrance slit, the light passes through the first transmissive region of the meniscus lens, after passing through the first transmissive region of the meniscus lens, the light is reflected by a first portion of the curved mirror towards the reflective region of the meniscus lens, after being reflected by the first portion of the curved mirror, the light passes through the second transmissive region of the meniscus lens, after passing through the second transmissive region of the meniscus lens, the light is diffracted and reflected by the reflective region of the meniscus lens towards a second portion of the curved mirror, after being diffracted and reflected by the reflective region of the meniscus lens, the light is reflected by a second portion of the curved mirror towards the third transmissive region of the meniscus lens, and after being reflected by the third portion of the curved mirror, the light passes through the third transmissive region of the meniscus lens and enters the light detector.

### BRIEF DESCRIPTION OF THE DRAWINGS

For a fuller understanding of the nature and advantages of the concepts disclosed herein, reference is made to the detailed description of preferred embodiments and the accompanying drawings.

FIG. 1 is a side view of an optical spectrometer according to one or more embodiments.

FIG. 2 is a bottom view of the meniscus lens shown in FIG. 1 according to one or more embodiments.

FIG. 3 is a cross section of the meniscus lens shown in FIG. 2 according to one or more embodiments.

FIG. 4 is an isometric view of the spectrometer shown in FIG. 1 to illustrate the light path(s) therethrough.

FIGS. 5 and 6 are front and isometric views of an optical spectrometer according to one or more embodiments.

FIGS. 7 and 8 are cross sections of the optical spectrometer shown in FIGS. 5 and 6, respectively.

FIG. 9 is an isolated end view of the spectrometer shown in FIG. 5 according to one or more embodiments.

FIG. 10 is a bottom view of a meniscus lens according to one or more embodiments.

FIG. 11 is a cross section of the meniscus lens shown in FIG. 10 according to one or more first embodiments.

FIG. 12 is a cross section of the meniscus lens shown in FIG. 10 according to one or more second embodiments.

### DETAILED DESCRIPTION

An optical spectrometer includes a light-entrance slit, a meniscus lens, a mirror, and a light detector. The meniscus lens includes optically transmissive regions and a central reflective region. The central reflective region includes a diffraction grating and a reflective material. Light enters the spectrometer through the light-entrance slit. The light then passes through a first optically transmissive region of the meniscus lens and is then reflected by the mirror towards the central reflective region. The light enters the central reflective region where the light is reflected and diffracted by a diffraction grating having a reflective coating. The reflected and diffracted light is then reflected by the mirror towards a second optically transmissive region of the meniscus lens. The light passes through second optically transmissive region of the meniscus lens and enters the light detector for analysis.

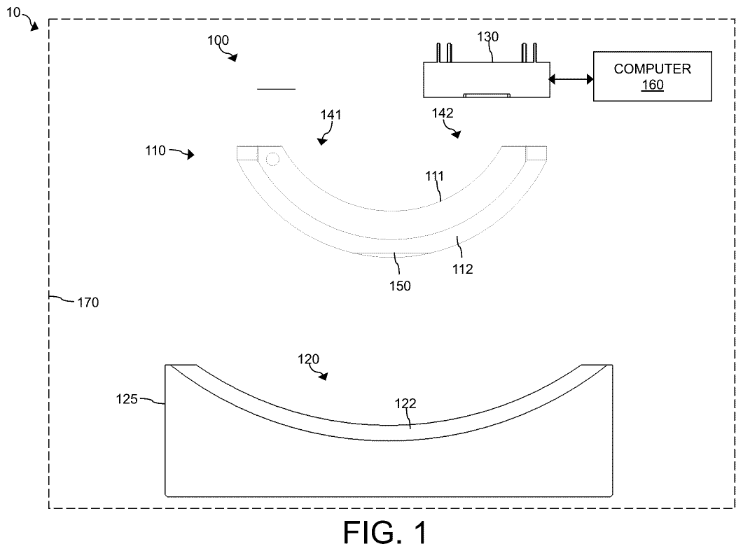

FIG. 1 is a side view of an optical spectrometer 10 according to one or more embodiments. The spectrometer 10 includes a light-entrance slit 100, a meniscus lens 110, a mirror 120, a light detector 130, and a housing 170. The light-entrance slit 100 allows a beam of light to pass into the spectrometer 10 for analysis. Prior to entering the spectrometer 10, the light can be reflected, refracted, and/or partially absorbed by an object such that one or more properties of the light may be modified by the object. The light-entrance slit 100 can be formed and/or defined in the housing 170.

The meniscus lens 110 is located between (a) the light-entrance slit 100 and the light detector 130 and (b) the mirror 120. In other words, the light-entrance slit 100 and the light detector are positioned above a first side 111 of the meniscus lens 110, and the mirror 120 is positioned below a second side 112 of the meniscus lens 110. The meniscus lens 110 includes first and second transmissive regions 141, 142 and a reflective region 150. The first and second transmissive regions 141, 142 are on the left and right sides/regions, respectively, of the meniscus lens 110 according to the perspective illustrated in FIG. 1. The reflective region 150 is in the center region of the meniscus lens 110 and between the first and second transmissive regions 141, 142. Due to the curvature of the meniscus lens 110, the reflective region 150 is between (a) the first and second transmissive regions 141, 142 and (b) the mirror 120.

The meniscus lens 110 is in the form of a section of a spherical dome. The first and second sides 111, 112 are parallel to each other and curved so as to define a uniform (or substantially uniform) thickness of the meniscus lens 110. In other embodiments, the lens 110 can have a variable thickness across at least a portion of the meniscus lens 110. Additionally or alternatively, the meniscus lens 110 can have a different shape such as a section of an elliptical dome, a section of a parabolic dome, a section of a cylindrical dome, a section of an aspheric dome, or another shape, which can be in addition to or in place of the spherical dome. The first side 111 of the meniscus lens 110 is concave, and the second side 112 of the meniscus lens 110 is convex.

The transmissive regions 141, 142 of the meniscus lens 110 comprise or consist of a material that is optically transmissive in the wavelengths of interest for the spectrometer 10. Examples of an optically transmissive material are or include glass or glasses, ceramics, crystalline materials, plastics, and/or polymers. The meniscus lens 110 can be generated, polished, cast, injection molded, replicated, diamond turned, and/or manufactured through additive and/or subtractive processes.

The reflective region 150 includes a diffraction grating and a reflective surface that are integrated into and/or defined in the second side 112 of the meniscus lens 110. In another embodiment, the reflective region 150 includes a diffraction grating and a reflective surface that are integrated into and/or defined in the first side 111 of the meniscus lens 110.

The meniscus lens 110 corrects for field curvature in the optical system. For example, the meniscus lens 110 can improve the optical performance of the optical spectrometer 10 at the edges of the image. The addition of the diffraction grating on the meniscus lens 110 maintains the center of curvature of each powered optical component in its location while maintaining a small form factor.

The mirror 120 is in the form of a section of a sphere (e.g., a spherical dome). The mirror 120 has a curved surface and defines a concave structure. The mirror 120 and the meniscus lens 110, which are both portions of respective spheres, at least in some embodiments, can be concentric or nearly concentric. In other embodiments, the mirror can be a section of an ellipse (e.g., an elliptical dome), a section of a parabola (e.g., a parabolic dome), a section of a cylinder (e.g., a cylindrical dome), aspherical (e.g., an aspherical dome), or another shape, which can be in addition to or in place of the section of the sphere.

The mirror 120 is formed on a mirror substrate 125. The mirror substrate 125 has a variable thickness and a planar bottom surface that can be used to support the mirror substrate 125. In other embodiments, the mirror substrate 125 can have a uniform thickness or a combination of variable and uniform thicknesses. The reflective region 150 is located between the reflective surface 122 of the mirror 120 and its center of curvature.

The light detector 130 can comprise a photo-sensitive detector. For example, the light detector 130 can include a charge coupled device (CCD) array, complementary metal oxide semiconductor (CMOS) image sensors, silicon (CCD/CMOS) sensors, InGaAs sensors, mercury cadmium telluride (MCT) sensors, InSb sensors, Strained Lattice (SLS) sensors, single photon avalanche diode/array (SPAD), avalanche photo diode/array (APD), and/or other light sensors.

The light detector 130 can be in electrical communication with a computer 160 that can analyze the output of the light detector 130 and/or can display the output of the light detector 130 on a display screen. The computer 160 includes one or more processing circuits such as one or more central processing units and/or one or more graphics processing units.

The components (e.g., the meniscus lens 110, the mirror 120, the light detector 130, and optionally the computer 160) of the spectrometer 10 can be contained within a housing 170 that is optically opaque to at least the wavelengths of interest for the spectrometer 10. The components of the spectrometer 10 can be mechanically supported by and/or mechanically mounted on the housing 170. The computer 160 can be contained within the housing 170 or can be located outside the housing 170.

The housing 170 can comprise or consist of one or more plastics (single or mixture, possibly, which can be reinforced or non-reinforced), composites (e.g., carbon fiber, an aramid fiber (e.g., Kevlar), and/or carbon fiber-reinforced plastic (CFRP)), and/or one or more ceramics. The housing 170 can be fabricated by machining, casting, injection molding, three-dimensional printing, and/or any combination of additive or subtractive manufacturing methods.

The spectrometer 10 can operate in the wavelengths (e.g., wavelengths of interest) of 250-2500 nm, including any subranges therein. In some embodiments, the spectrometer 10 can operate at higher wavelengths (e.g., above 2500 nm) but different materials may be needed to operate at these higher wavelengths.

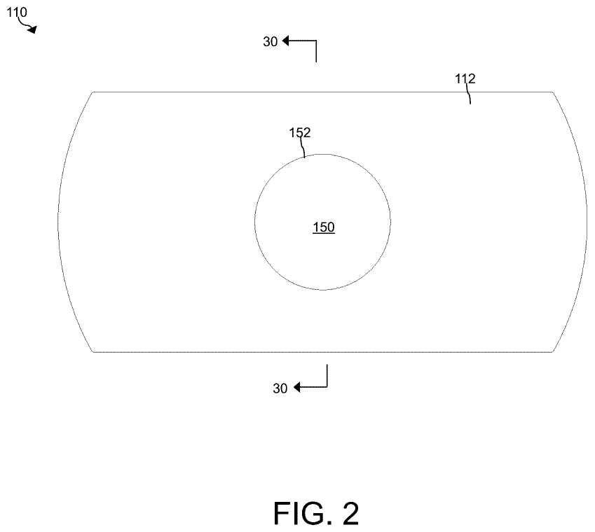

FIG. 2 is a bottom view of the meniscus lens 110 according to one or more embodiments. The reflective region 150 has a round or circular surface 152. The reflective region 150 has a depth such that the reflective region 150 defines a cylinder in the body of the meniscus lens 110.

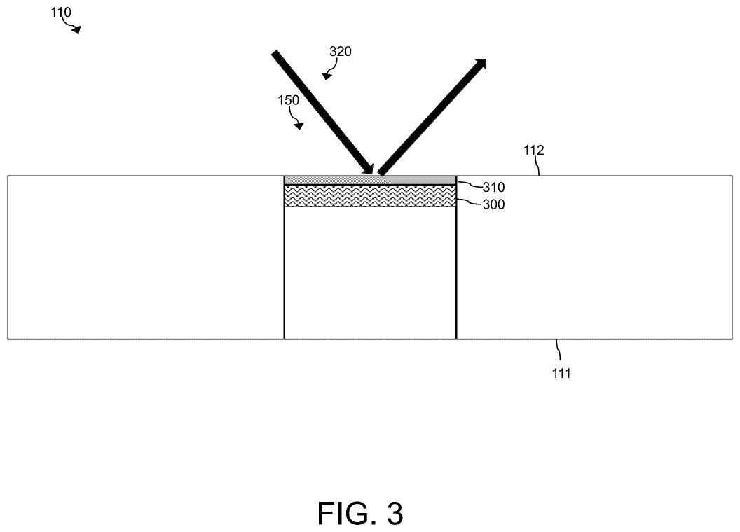

FIG. 3 is a cross section of the meniscus lens 110 taken through plane 30 in FIG. 2 according to one or more embodiments. The reflective region 150 includes a diffraction grating 300 and a reflector 310. The reflector 310 can comprise or consist of a coating of gold, aluminum, silver, any combination of metallic and non-metallic materials and/or another reflective material that provides high reflectivity in the operating wavelengths of the optical spectrometer 10.

The diffraction grating 300 includes grooves that can be triangular, sinusoidal, rectangular, square, and/or an arbitrary shape. The diffraction grating 300 can be produced with a replication process, an additive process, and/or a subtractive process.

The reflector 310 is disposed on the second side 112 of the meniscus lens 110. The diffraction grating 300 is closer to the first side 111 of the meniscus lens 110 compared to the reflector 310. In addition, the reflector 310 is between the diffraction grating 300 and the mirror 120 (e.g., as shown in FIG. 1).

In operation, light 320 incident on the reflective region 150 is reflected by the reflector 310 and diffracted by the diffraction grating 300.

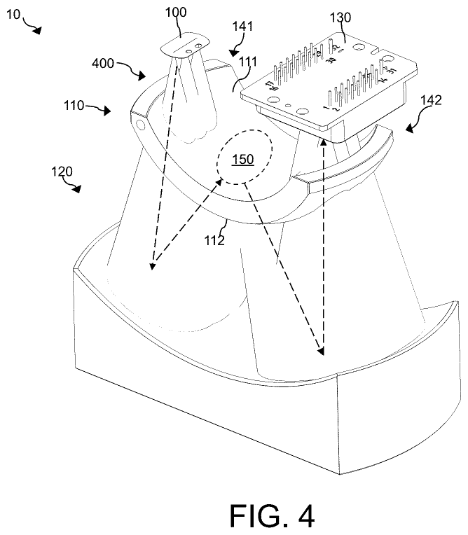

FIG. 4 is an isometric view of the spectrometer 10 to illustrate the light path(s) therethrough. Light 400 enters the spectrometer 10 through the light-entrance slit 100. After entering the spectrometer 10, the light 400 passes through the first transmissive region 141 of the meniscus lens 110. The light 400 is then reflected and by the mirror 120 (e.g., by a first portion of the mirror 120) and redirected towards the reflective region 150 defined in the second side 112 of the meniscus lens 110. The reflective region 150 is illustrated with a dashed line to indicate that it would not ordinarily be viewable from this perspective but is shown for clarity purposes only. The light 400 is reflected and diffracted by the reflective region 150 (e.g., by the reflective surface 310 and the diffraction grating 300, respectively).

The light 400 reflected and diffracted by the reflective region 150 is directed back towards the mirror 120 (e.g., by a second portion of the mirror 120) and redirected towards the second transmissive region 142 of the meniscus lens 110. After passing through the second transmissive region 142 of the meniscus lens 110, the light 400 enters the light detector 130 where the wavelengths and relative intensities of the light 400 are detected to determine the spectrum of the light 400.

The light 400 is generally diverging or spreading after passing through the light-entrance slit 100. The light 400 is generally converging or narrowing as the light 400 enters the light detector 130.

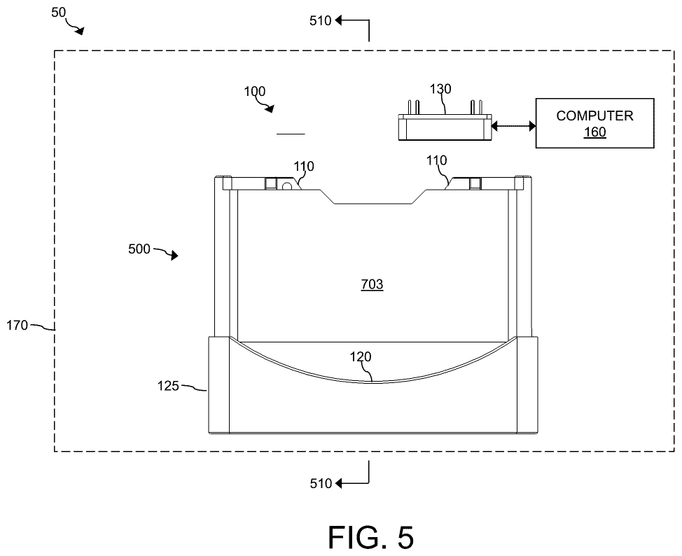

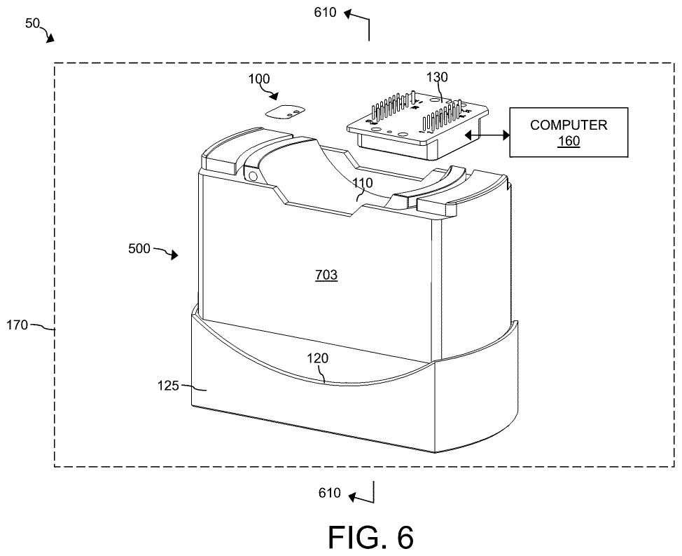

FIGS. 5 and 6 are front and isometric views of an optical spectrometer 50 according to one or more embodiments. The optical spectrometer 50 is the same as the optical spectrometer 10 except that optical spectrometer 50 includes a spacer 500 located between the meniscus lens 110 and the mirror 120.

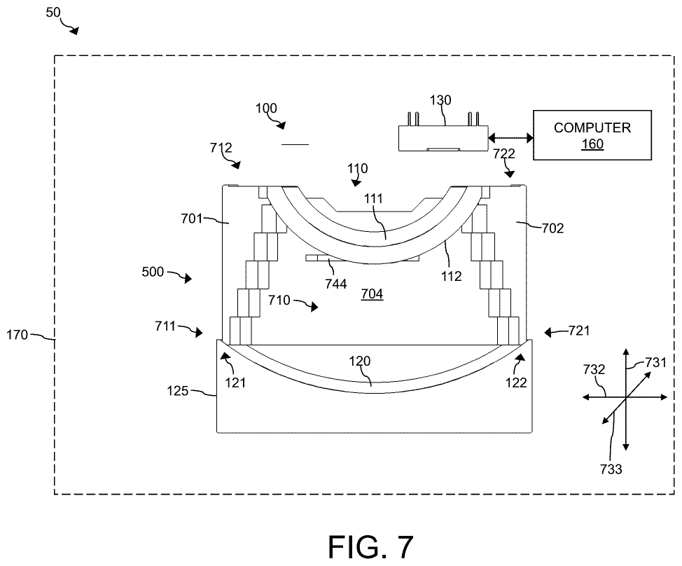

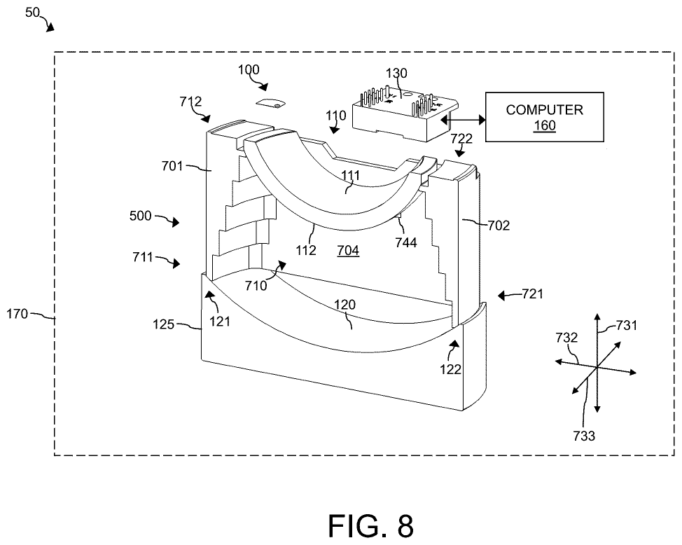

FIGS. 7 and 8 are cross sections taken through planes 510 and 610 of FIGS. 5 and 6, respectively. Plane 510 can be the same as or different than plane 610. The spacer 500 has first and second walls 701, 702 that define a cavity 710 in the center and/or middle sections. The cavity 710 is aligned with the portion between the meniscus lens 110 and the mirror 120 where light passes when the spectrometer 50 is in use, for example as shown in FIG. 4, such that the light passes through the cavity 710. In one or more embodiments, the light does not pass through the spacer 500 other than the cavity 710.

The first wall 701 of the spacer 500 includes a first end 711 that is mechanically supported on a first side or edge 121 (e.g., the left side in FIGS. 7 and 8) of the mirror 120 and a second end 712 that is mechanically coupled to and/or mechanically supports a first side/edge (e.g., the left side in FIGS. 7 and 8) of the meniscus lens 110. The second wall 702 of the spacer 500 includes a first end 721 that is mechanically supported on a second side or edge 122 (e.g., the right side in FIGS. 7 and 8) of the mirror 120 and a second end 722 that is mechanically coupled to and/or mechanically supports a second side/edge (e.g., the right side in FIGS. 7 and 8) of the meniscus lens 110.

The first and second walls 701, 702 have a respective height, a respective width, and a respective length that can be measured with respect to first, second, and third axes 731, 732, and 733, respectively, which are mutually orthogonal. The distance between the meniscus lens 110 and the mirror 120 can be measured with respect to the first axis 731. In addition, the thickness of the meniscus lens 1120 (e.g., between the first and second sides 111, 112) can be measured with respect to the first axis 731. The distance between the first and second walls 701, 702 can be measured with respect to the second axis 732.

The respective width of the first and second walls 701, 702 can be variable. In one or more embodiments, the respective width of the first and second walls 701, 702 is smaller at the respective first end 711, 721 compared to at the respective second end 712, 722. For example, the respective width of the first and second walls 701, 702 can taper from the respective second end 712, 722 to the respective first end 711, 721. Likewise, the respective width of the first and second walls 701, 702 can expand from the respective first end 711, 721 to the respective second end 712, 722. The respective width of the first and second walls 701, 702 can taper or expand in a stepwise fashion or in a continuous fashion, for example, in the form of a triangular wedge or a curved surface.

The width of the cavity 710, as measured with respect to the second axis 732, can be smaller at the top of the first and second walls 701, 702 (at the respective second ends 712, 722) near the meniscus lens 110 compared to at the bottom of the first and second walls 701, 702 (at the respective first ends 711, 721) near the mirror 120. The width of the cavity 710 at the top of the first and second walls 701, 702 is configured to receive the meniscus lens 110 and allow the first and second walls 701, 702 to mechanically contact and support the second side 112 of the meniscus lens 110. The width of the cavity 710 can be larger at the bottom of the first and second bodies (at the first ends) near the mirror 120. The width of the cavity 710 can vary through steps or continuously which can be defined by the respective width of the first and second walls 701, 702.

The size and geometry of the first and second walls 701, 702 are configured to provide a predetermined relative spacing between and a relative alignment of the meniscus lens 110 and the mirror 120.

The spacer 500 can include third and fourth walls 703, 704 that mechanically connect the first and second walls 701, 702 and that further define the cavity 710. Only the third wall 703 is illustrated in FIGS. 5 and 6. Only the fourth wall 704 is illustrated in FIGS. 7 and 8. The distance between the third and fourth walls 703, 704 can be measured with respect to the third axis 733.

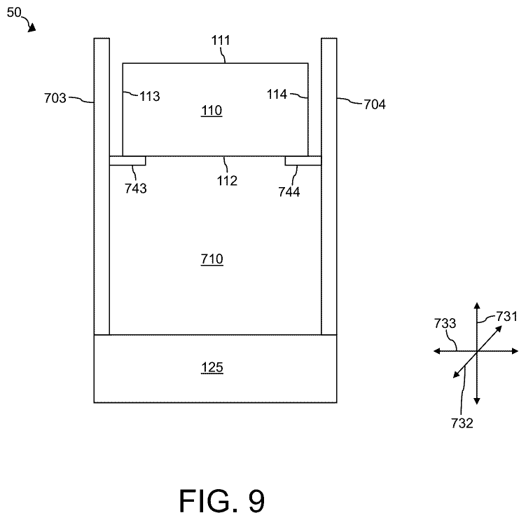

FIG. 9 is an isolated end view of the spectrometer 50 according to one or more embodiments. The third and fourth walls 703, 704 include a respective fin or shelf 743, 744 that is configured to mechanically engage and support the second side 112 of the meniscus lens 110 below the third and fourth sides 113, 114, respectively, of the meniscus lens 110. The fin/shelf 744 is also shown in FIGS. 7 and 8. The housing 170, the first and second walls 701, 702, the light-entrance slit 100, the light detector 130, and the computer 160 are not shown in FIG. 9 for illustration purposes only.

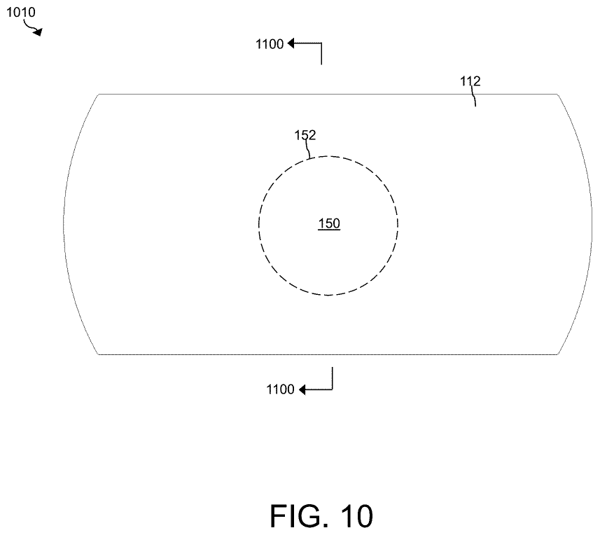

FIG. 10 is a bottom view of a meniscus lens 1010 according to one or more embodiments. The meniscus lens 1010 is the same as the meniscus lens 110 except that in the meniscus lens 1010, the reflective region 150 is disposed between the first and second sides 111, 112 of the meniscus lens 1010. The meniscus lens 1010 can be included in the optical spectrometer 10 and/or the optical spectrometer 50 instead of the meniscus lens 110.

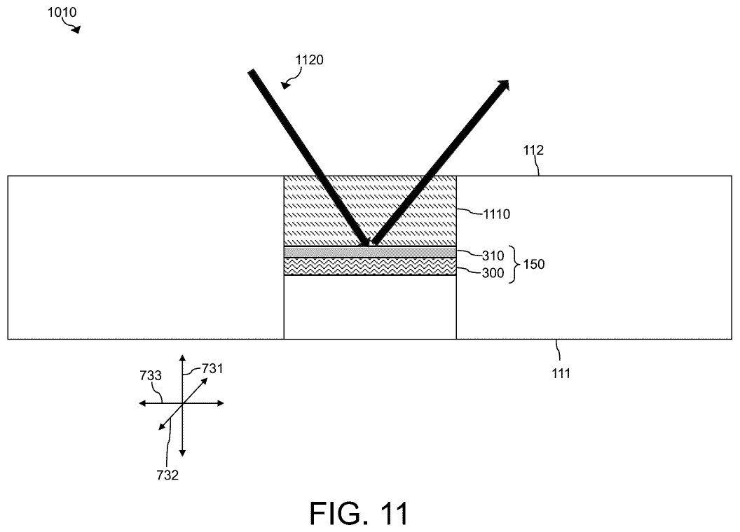

FIG. 11 is a cross section of the meniscus lens 1010 taken through plane 1100 in FIG. 10 according to one or more first embodiments. The cross section illustrated in FIG. 11 is the same as that shown in FIG. 3 except that in the cross section illustrated in FIG. 11 the meniscus lens 1010 includes a third transmissive region 1110 that extends from the second side 112 of the meniscus lens 1010 to the reflective region 150 (e.g., to the reflector 310). The reflector 310 is between the third transmissive region 1110 and the diffraction grating 300. The third transmissive region 1110 can define, in part, the second side 112 of the meniscus lens 1010. The third transmissive region 1110 can be same and/or comprise the same material(s) as the first transmissive region 141 and/or as the second transmissive region 142.

In operation, light 1120 passes through the third transmissive region 1110 before the light 1120 is reflected by the reflector 310 and diffracted by the diffraction grating 300.

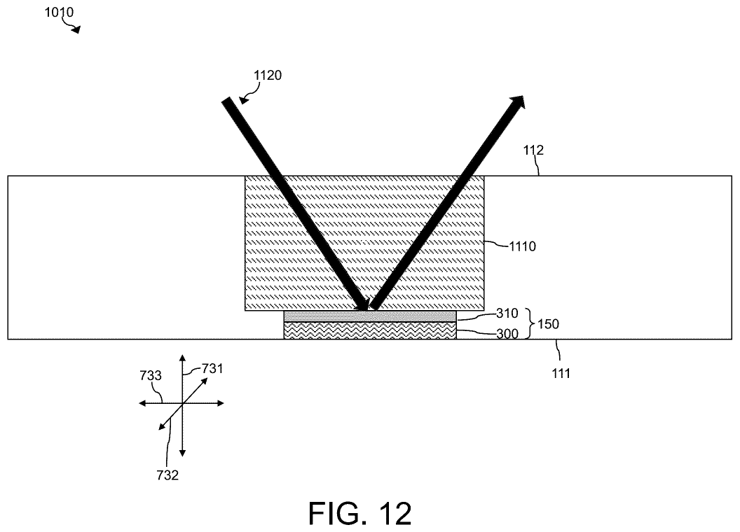

FIG. 12 is a cross section of the meniscus lens 1010 taken through plane 1100 in FIG. 10 according to one or more second embodiments. The diffraction grating 300 is disposed adjacent to the first side 111 of the meniscus lens 1010 so as to define, in part, the first side 111 of the meniscus lens 1010. The diffraction grating 300 extends from the first side 111 of the meniscus lens 1010.

In the cross section illustrated in FIG. 11 and/or in the cross section illustrated in FIG. 12, the third transmissive region 1110 can have a length, as measured with respect to the third axis 733, that is larger than the length of the reflective region 150 to provide enough material through which the light 1120 can pass, for example as shown in the cross section illustrated in FIG. 12.

In operation, light 1120 passes through the third transmissive region 1110 before the light 1120 is reflected by the reflector 310 and diffracted by the diffraction grating 300.

The invention should not be considered limited to the particular embodiments described above, but rather should be understood to cover all aspects of the invention as fairly set out in the attached claims. Various modifications, equivalent processes, as well as numerous structures to which the invention may be applicable, will be apparent to those skilled in the art to which the invention is directed upon review of this disclosure. The claims are intended to cover such modifications and equivalents.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

What is claimed is:

1. An optical spectrometer comprising:
a housing having a light-entrance slit defined therein;
a meniscus lens having first and second transmissive regions and a reflective region, the reflective region including:
a reflector, and
a diffraction grating;
a curved mirror; and
a light detector,
wherein:
the meniscus lens is between the light-entrance slit and the curved mirror, and
the optical spectrometer is configured such that:
a light enters the optical spectrometer through the light-entrance slit,
after entering through the light-entrance slit, the light passes through the first transmissive region of the meniscus lens,
after passing through the first transmissive region of the meniscus lens, the light is reflected by a first portion of the curved mirror towards the reflective region of the meniscus lens,
after being reflected by the first portion of the curved mirror, the light is diffracted and reflected by the reflective region of the meniscus lens towards a second portion of the curved mirror,
after being diffracted and reflected by the reflective region of the meniscus lens, the light is reflected by a second portion of the curved mirror towards the second transmissive region of the meniscus lens, and
after being reflected by the second portion of the curved mirror, the light passes through the second transmissive region of the meniscus lens and enters the light detector.

2. The optical spectrometer of claim 1, wherein the reflective region is between the first and second transmissive regions.

3. The optical spectrometer of claim 1, wherein:
the meniscus lens has first and second sides,
the first side is closer to the light-entrance slit and the light detector than the second side,
the second side is closer to the curved mirror than the first side, and
the second side is defined, in part, by the reflective region.

4. The optical spectrometer of claim 1, wherein:
the meniscus lens has first and second sides,
the first side is closer to the light-entrance slit and the light detector than the second side,
the second side is closer to the curved mirror than the first side, and
the diffraction grating is closer to the first side compared to the reflector.

5. The optical spectrometer of claim 4, wherein:
the reflector comprises a coating of gold, aluminum, and/or silver, and
the diffraction grating comprises a plurality of grooves.

6. The optical spectrometer of claim 5, wherein the grooves include triangular, sinusoidal, rectangular, and/or square shapes.

7. The optical spectrometer of claim 3, wherein:
the first side of the meniscus lens is concave, and
the second side of the meniscus lens is convex.

8. The optical spectrometer of claim 3, wherein the meniscus lens comprises a section of a spherical dome.

9. The optical spectrometer of claim 1, wherein the curved mirror comprises a section of a spherical dome.

10. The optical spectrometer of claim 1, wherein the curved mirror is formed on a mirror substrate, the mirror substrate having a variable thickness.

11. The optical spectrometer of claim 1, wherein the first and second transmissive regions are optically transmissive to one or more wavelengths within a wavelength range of 250 nm to 2500 nm.

12. An optical spectrometer comprising:
a housing having a light-entrance slit defined therein;
a meniscus lens having first and second transmissive regions and a reflective region, the reflective region including:
a reflector, and
a diffraction grating;
a curved mirror; and
a light detector,
a spacer disposed on the curved mirror and mechanically supporting the meniscus lens, the spacer defining a cavity,
wherein:
the meniscus lens is between the light-entrance slit and the curved mirror, and
the optical spectrometer is configured such that:
a light enters the optical spectrometer through the light-entrance slit,
after entering through the light-entrance slit, the light passes through the first transmissive region of the meniscus lens,
after passing through the first transmissive region of the meniscus lens, the light passes through the cavity and is reflected by a first portion of the curved mirror towards the reflective region of the meniscus lens,
after being reflected by the first portion of the curved mirror, the light passes through the cavity and is diffracted and reflected by the reflective region of the meniscus lens towards a second portion of the curved mirror,
after being diffracted and reflected by the reflective region of the meniscus lens, the light passes through the cavity and is reflected by a second portion of the curved mirror towards the second transmissive region of the meniscus lens, and
after being reflected by the second portion of the curved mirror, the light passes through the second transmissive region of the meniscus lens and enters the light detector.

13. The optical spectrometer of claim 12, wherein the spacer includes:
a first wall that mechanically engages a first side of the meniscus lens, and
a second wall that mechanically engages a second side of the meniscus lens, the first and second sides on opposing sides of the meniscus lens.

14. The optical spectrometer of claim 13, wherein the reflective region of the meniscus lens is between the first and second sides.

15. The optical spectrometer of claim 13, wherein:
each of the first and second walls has a respective height, a respective width, and a respective length that are measured with respect to first, second, and third axes, respectively, that are mutually orthogonal,
a distance between the meniscus lens and the curved mirror is measured with respect to the first axis,
a distance between the first and second walls is measured with respect to the second axis, and
the respective width of the first and second walls is variable.

16. The optical spectrometer of claim 15, wherein:
each of the first and second walls has a respective first end and a respective second end,
the respective first end is closer to the meniscus lens than the respective second end, and
the respective width is greater at the respective first end than at the respective second end.

17. The optical spectrometer of claim 15, wherein the spacer further includes:
a third wall that mechanically engages a third side of the meniscus lens, and
a fourth wall that mechanically engages a fourth side of the meniscus lens.

18. The optical spectrometer of claim 17, wherein:
the third wall includes a first fin that mechanically engages the third side of the meniscus lens, and
the fourth wall includes a second fin that mechanically engages the third side of the meniscus lens.

19. A system comprising:
the optical spectrometer of claim 12; and
a computer having an input coupled to an output of the light detector.

20. An optical spectrometer comprising:
a housing having a light-entrance slit defined therein;
a curved mirror;
a meniscus lens having first, second, and third transmissive regions and a reflective region, the reflective region including a reflector and a diffraction grating, wherein:
the second transmissive region is between the first and third transmissive regions, and
the second transmissive region is between the reflective region and the curved mirror; and
a light detector,
wherein:
the meniscus lens is between the light-entrance slit and the curved mirror,
the optical spectrometer is configured such that:
a light enters the optical spectrometer through the light-entrance slit,
after entering through the light-entrance slit, the light passes through the first transmissive region of the meniscus lens,
after passing through the first transmissive region of the meniscus lens, the light is reflected by a first portion of the curved mirror towards the reflective region of the meniscus lens,
after being reflected by the first portion of the curved mirror, the light passes through the second transmissive region of the meniscus lens,
after passing through the second transmissive region of the meniscus lens, the light is diffracted and reflected by the reflective region of the meniscus lens towards a second portion of the curved mirror,
after being diffracted and reflected by the reflective region of the meniscus lens, the light is reflected by a second portion of the curved mirror towards the third transmissive region of the meniscus lens, and
after being reflected by the third portion of the curved mirror, the light passes through the third transmissive region of the meniscus lens and enters the light detector.
